(19) United States
(12) Patent Application Publication
(10) Pub. No.: US 2015/0356347 A1
(43) Pub. Date: Dec. 10, 2015

(54) METHOD FOR ACQUIRING FACIAL MOTION DATA

(71) Applicant: Activision Publishing, Inc., Santa Monica, CA (US)

(72) Inventor: Jamie Egerton, Santa Monica, CA (US)

(21) Appl. No.: 14/297,418

(22) Filed: Jun. 5, 2014

(51) Int. Cl. G06K 9/00; G06T 13/40; G06F 3/14; G06T 7/20; G06F 3/01

(52) U.S. Cl. CPC G06K 9/00255; G06K 9/00315; G06T 7/2033; G06T 7/2046; G06F 3/011; G06F 3/1415; G06T 13/40; G06T 2207/30201; G06T 2207/10016

(57) ABSTRACT

A method for acquiring facial motion data includes a video reference and a timing cue to guide and instruct an actor performing a facial expression. The timing cue may include a video component and/or an audio component.

### FIELD OF THE INVENTION

The present invention relates generally to acquiring facial motion data, typically for use with facial animation control systems.

### BACKGROUND OF THE INVENTION

Facial animation data is used to drive facial control systems for video games and other video animation. A catalogue of facial expressions created by Paul Ekman and Wallace Friesen known as FACS (Facial Action Coding System) was published in 1978.

Typically, to drive facial expressions for a particular video-game character or application, a core set of face data roughly corresponding to FACS is required from an actor. To obtain high fidelity for the video game character, it is not uncommon to require more than a hundred poses from the actor. Doing so can be time-consuming and require a significant amount of rehearsal and direction. Likewise, once the data is captured, associating the data with facial pose definitions in animation software requires further time and skill.

Thus, it would be desirable to have a system and method to capture a core set of facial animation data from an actor, without relying significantly on direction from a director, and without having to manually synch up the data with facial pose definitions in animation software.

### SUMMARY OF THE INVENTION

One aspect of the invention includes use of a video reference to guide and/or direct an actor as to when and how to make facial expressions for capture by data capture software. Another aspect includes timing cues to guide and/or instruct the actor when and how to make the facial expressions. The timing cues may include a video component and/or an audio component. Typically, the timing cues direct the actor to make a posed facial expression from a neutral facial expression, and then the neutral facial expression from the posed facial expression. The actor's facial expressions are captured during the relevant time periods, which are keyed off the timing cues. The data capture software is thus able to identify images of the actor representing the posed facial expression, the neutral facial expression, and transitions from one to the other. The video references and/or timing cues may be combined onto a single audio-visual work referred to herein as a “video deck,” which may be played for the actor during a facial expression capturing session. The video deck may be operatively connected to and/or run in synch with image capturing software.

In one aspect of the invention, an image of a person with a first facial expression (typically a posed facial expression) is displayed on a display for a first time period, and a first timing cue is output during that period. The timing cue informs the actor of a start time and an end time of the first time period, and typically this is a countdown period to when the image capture will begin. A second image of the person ith the second facial expression is then displayed for a second time period, and a second timing cue is output during that period. Again, the timing cue informs the actor of a start time and an end time of this time period, and typically this is the time period during which the actor makes the neutral facial expression but is then prepared to make the posed facial expression that was displayed during the first time period. An image of the person with the first facial expression is then again displayed for a third time period, and a third timing cue is output during that period. This timing cue also informs the actor of a start time and an end time of this time period, and typically this is the time period during which the actor makes the posed facial expression. An image of the person with the second facial expression is then again displayed for a fourth time period, and a fourth timing cue is output during that period. This timing cue informs the actor of a start time and an end time of this time period, and typically this is the time period during which the actor makes the neutral facial expression again. In this manner, the data capture software is able to capture images of the neutral expression, the posed expression, and transitions between the two, and know which images represent which poses and transitions, due to the timing cues. This information may then be included in the recorded data and associated with corresponding FACS definitions.

The timing cues may include a video component (e.g., an image of a person making the expression the actor will be or should be making), and an audio component (e.g., a beep sequence with easily identifiable start and end beeps). The process may be repeated multiple times for a particular facial expression, and multiple facial expressions may be captured during a single session.

### BRIEF DESCRIPTION OF THE DRAWINGS

FIG. 1 shows an electronic display displaying an image of a person with a posed facial expression;

FIG. 2 shows the display of FIG. 1 displaying an image of the person with a neutral facial expression;

FIG. 3 shows the display of FIG. 1 again displaying an image of the person with the posed facial expression;

FIG. 4 shows the display of FIG. 1 again displaying an image of the person with the neutral facial expression; and

FIG. 5 is a flowchart illustrating a method of the present invention.

### DETAILED DESCRIPTION OF THE EMBODIMENTS

Preferred embodiments of the present invention will now be described with reference to the above-described drawings. In a specific embodiment, methods of the present invention are implemented in part using a video deck, which is a collection of sequential video images of posed expressions and neutral expressions accompanied by audio and/or visual timing cues, as explained herein. Software controlling presentation of the video deck and timing cues is programmed to capture images of an actor mimicking the displayed images at times associated with the timing cues. In this manner, the software may associate the captured images of the actor with FACS definitions corresponding to the displayed images, based on the timing cues.

By using a video deck as described herein, the direction of actors and the acquisition of facial motion data is made more efficient. For example, the actor may mimic the video images of the video deck as they are displayed in sequence, with the aid of audio and/or visual timing cues, such that by repetition, the actor will be able to achieve a consistent timing in the performance of each facial expression pose. The timing consistency allows for automation of the processing of each pose prior to being used as input to a facial control system. Thus, use of a human director is minimized, and synching up the poses with FACS definitions in the software is more automated due to the timing cues.

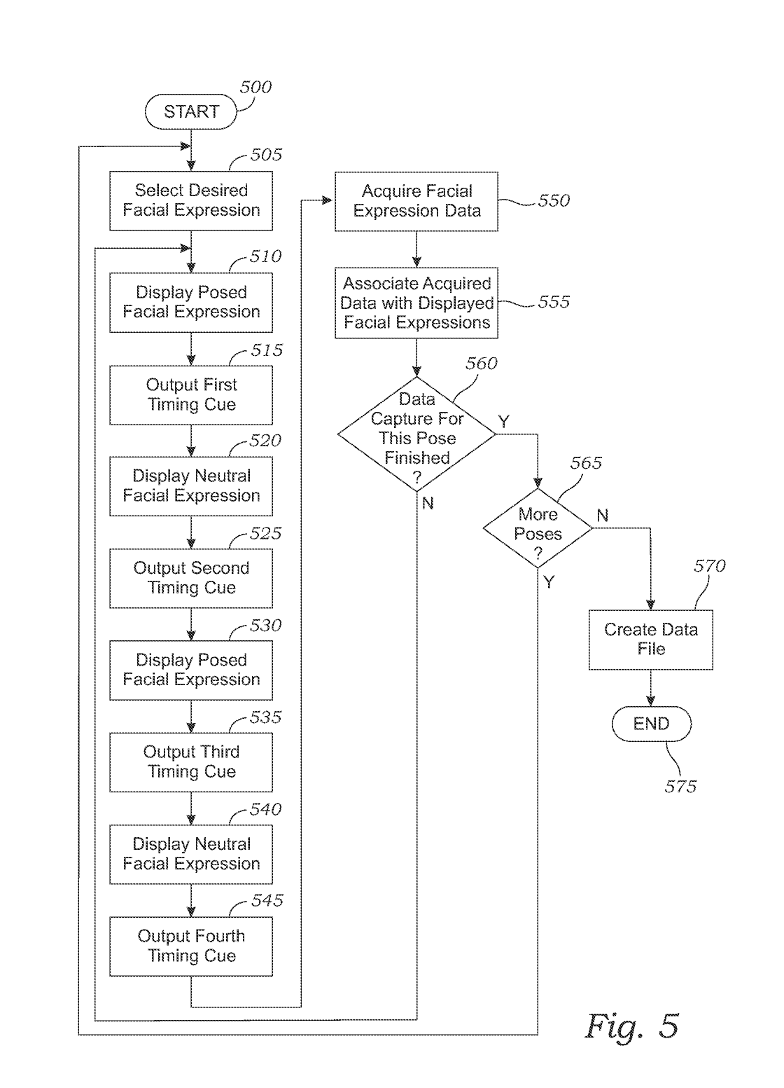

Turning now to FIG. 5, a flowchart illustrating a method according to the present invention is shown. The flowchart will be described using an example in which images of a person are displayed for a particular facial expression set by first displaying a still shot of a posed image, then displaying an image of a neutral expression, then displaying an image of the posed expression, then displaying an image of the neutral expression, all with associated timing cues as explained herein. However, other embodiments display images in different sequences, and use timing cues for some but not all of the images. The images may be still shots, or motion videos. For example, display of the neutral expressions may be accomplished by the person transitioning in motion video from the posed expression to the neutral expression. Likeiwise, display of the posed expression may be accomplished by the person transitioning in motion video from the neutral expression to the posed expression. Using motion videos in this manner further aids the actor by allowing the actor to see how the transitions should be performed.

The method begins at Step 500. At Step 505, a desired facial expression is selected. This step may be accomplished, for example, simply by presetting the video deck to include the desired facial expressions to be captured in a desired order. Thus, if the first facial expression to be captured is an “upper lip raise,” then the video deck would be set to include an “upper lip raise” image sequence at the beginning. Alternatively, the software may allow an option for the actor or director to select a particular facial expression to be captured, prior to activating the corresponding image sequence to be mimicked.

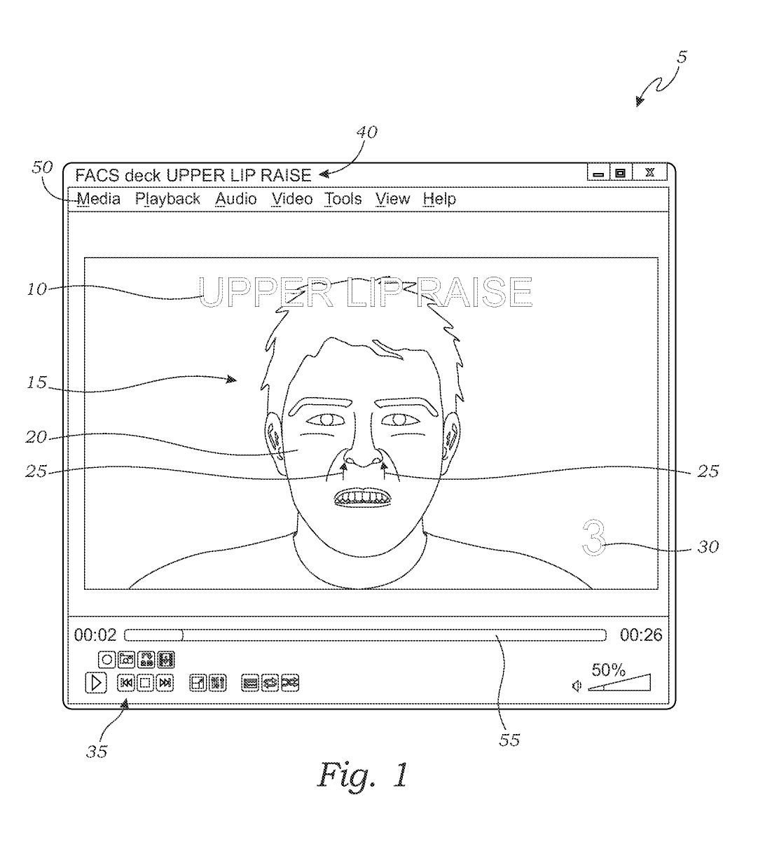

Once a desired facial expression is selected, either by preset or automatic presentation from the software, by manual selection, or otherwise, an image of a person with a first facial expression is displayed on an electronic display as seen at Step 510. This may be automatic, or require an activation trigger such as a software START button, voice command, etc. The image displayed at Step 510 in this example is a still shot of a person with the desired pose, namely “an upper lip raise”, as seen in FIG. 1. “Person” as used in this context may be a real person, a robot, an animation, or other visual representation of a person, creature, etc.

This image 5 informs the actor of the facial expression to be captured, and may include not only an image of the person 15 making the desired posed facial expression 20, but also a visual label 10 identifying the pose. Additionally, the image 5 may include markers 25 indicating to the actor what facial movements will be required to accomplish the desired posed facial expression 20. In FIG. 1, the markers 25 indicate to the actor that both sides of the upper lip should be raised at the appropriate time(s). These multiple visual cues (10, 15, 25) combine to present an integrated visual instruction to the actor. Various actors may benefit from only one, or any combination of the visual cues, depending on the actor's natural mode of learning. FIG. 1 also shows basic software features such as a screen title 40, menu 50, transport controls 35, and timing bar 55.

The image is displayed for a first time period having a first start time and a first end time. This time period may be preset or programmable, to a duration sufficient to give the actor time to prepare to make the pose once the cues to do so are given. Some examples of the duration are approximately 3 seconds, and between approximately 1 and 5 seconds.

During the first time period while the image is being displayed, a first timing cue is output as seen at Step 515. The first timing cue may include a timing cue representing the first start time and a timing cue representing the first end time, and may be audio, visual, or both. For example, the first timing cue may be an audio beep sequence (a sequence of one or more beeps). In this example, the first timing cue is a first audio beep sequence of n beeps (n is greater than or equal to 3), corresponding to an n-second countdown. The first beep represents the first start time, and the last beep represents the first end time. All of the beeps in the first audio beep sequence may be at the same frequency, volume, and duration, or those characteristics may vary. As the beeps occur, a visual timing indicator (e.g., 30 in FIG. 1) may be displayed corresponding to the beeps. For a three-beep sequence, the timing indicator 30 may be a numeric countdown 3-2-1 in synch with the beeps, thus giving the actor both a visual and audio timing cue as to when the capture process will begin. Other visual timing indicators may be used, such as an increasing or decreasing progress bar, or other changing graphic such as a deflating balloon, an emptying container, a shedding tree, a filling circle, an emptying sand timer, etc.

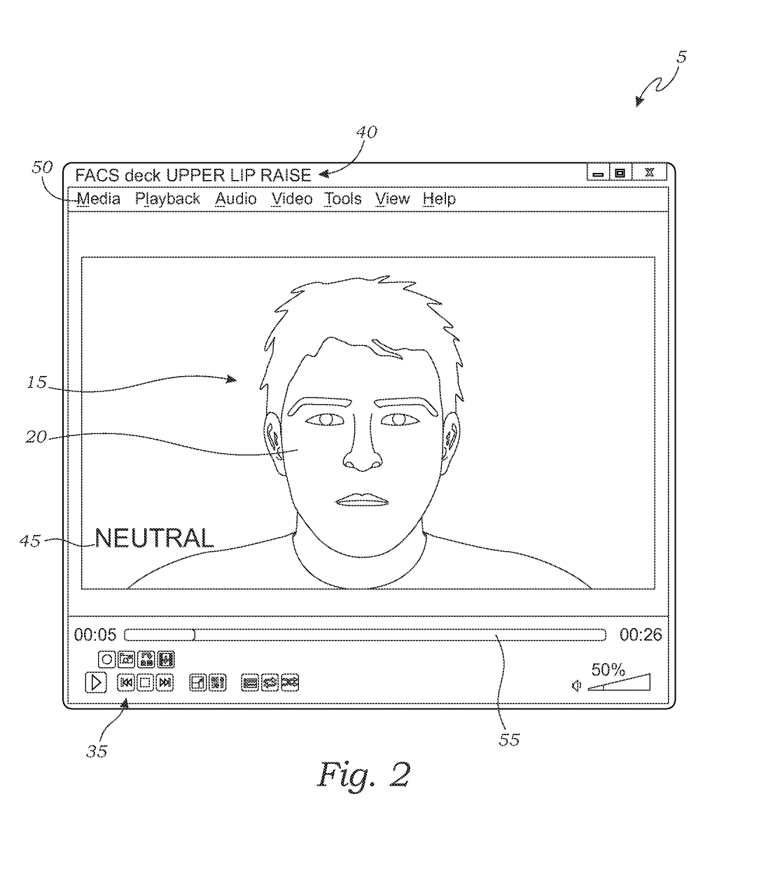

Once the first time period is over, the actor should be prepared to perform the desired pose. The next step in the process is at Step 520, where an image of the person with a second facial expression is displayed for a second time period having a second start time and a second end time. In this example, the second facial expression is a neutral facial expression as seen in FIG. 2. Thus, the actor will perform the neutral facial expression (or more likely, will maintain his or her then-current neutral expression) during this time period. This image may include a visual label 45 identifying a facial mode associated with the facial expression. In FIG. 2, for example, a visual label 45 is the word “NEUTRAL,” indicating the facial expression during this time period should be neutral, as shown in the image.

Similar to the first time period, here a second timing cue is output as seen at Step 525. Also similar, here the second timing cue may include a timing cue representing the second start time and a timing cue representing the second end time, and may be audio, visual, or both. For example, the second timing cue may also be an audio beep sequence. In this example, the second timing cue is a second audio beep sequence of n beeps (n is greater than or equal to 2), corresponding to an n-second time period. The first beep represents the second start time, and the last beep represents the second end time. All of the beeps in the second audio beep sequence may be at the same frequency, volume, and duration, or those characteristics may vary. Each successive beep in the second audio beep sequence may be at a successively higher (or lower) frequency than the previous beep in the sequence. Also, the first beep may be at a different frequency than the last beep of the first beep sequence. These criteria help create a recognizable sound pattern for the actor. The actor knows to maintain the facial expression in the displayed image (in this example, a neutral expression) for the duration of this second time period. The actor knows the start and end of the second time period based on the timing cues.

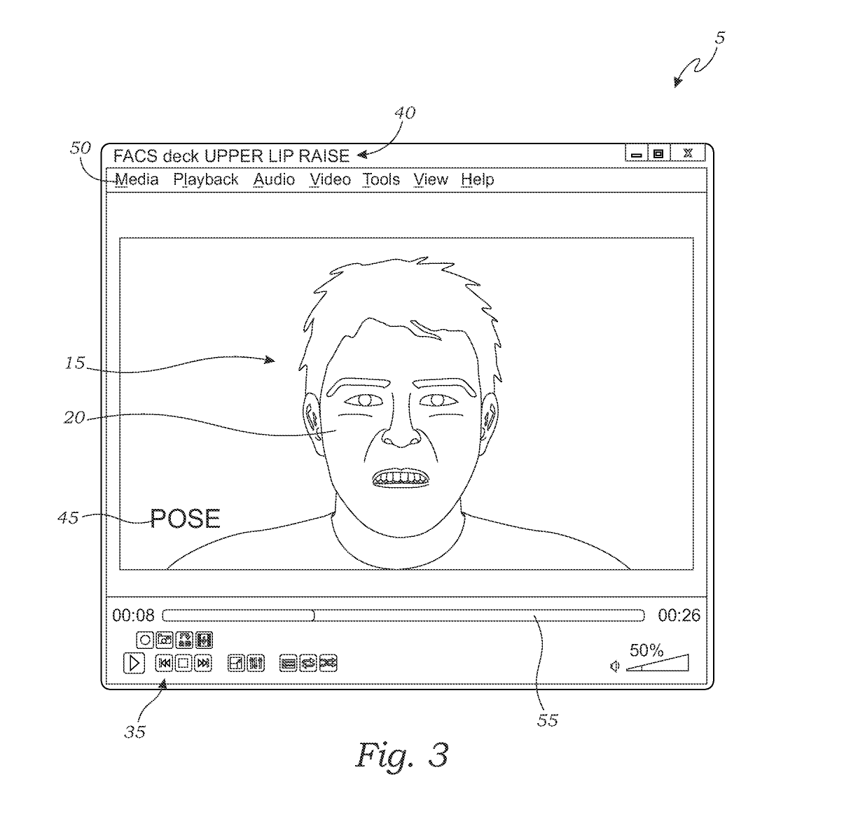

After the second time period has ended as indicated by the end of the second timing cue, and the actor has performed or maintained his facial expression corresponding to the image then being displayed, an image of the person with the first facial expression (in this example the posed facial expression of an “upper lip raise”) is displayed for a third time period having a third start time and a third end time, as seen at Step 530. This is shown also in FIG. 3. Thus, the actor will transition from the neutral facial expression to the posed facial expression at the start of this time period, and maintain the posed expression for the duration of this time period as informed by the timing cue(s) for this time period. Similar to FIG. 2, this image may include a visual label 45 identifying a facial mode associated with the facial expression. In FIG. 3 the visual label 45 is the word “POSE,” indicating the facial expression during this time period should be the pose as shown in the image.

Similar to the first and second time periods, here a third timing cue is output as seen at Step 535. Also similar, here the third timing cue may include a timing cue representing the third start time and a timing cue representing the third end time, and may be audio, visual, or both. For example, the third timing cue may also be an audio beep sequence. In this example, the third timing cue is a third audio beep sequence of n beeps (n is greater than or equal to 2), corresponding to an n-second time period. The first beep represents the third start time, and the last beep represents the third end time. All of the beeps in the third audio beep sequence may be at the same frequency, volume, and duration, or those characteristics may vary. Each successive beep in the third audio beep sequence may be at a successively lower (or higher) frequency than the previous beep in the sequence. Also, the first beep may be at a different frequency than the last beep of the second beep sequence. These criteria help to further create a recognizable sound pattern for the actor. The actor knows to maintain the facial expression in the displayed image (in this example, a posed expression) for the duration of this third time period. The actor knows the start and end of the third time period based on the timing cues.

Once the first three time periods are over, and the actor has thus seen the pose (first time period), performed or maintained a neutral expression (second time period), and transitioned from a neutral expression to the posed expression (third time period), all according to the visual images and audio and/or visual timing cues, an image of the person with the second facial expression is again displayed, for a fourth time period having a fourth start time and a fourth end time, as seen at Step 540. Similar to the first, second, and third time periods, here a fourth timing cue is output as seen at Step 545. Also similar, here the fourth timing cue may include a timing cue representing the fourth start time and a timing cue representing the fourth end time, and may be audio, visual, or both. For example, the fourth timing cue may also be an audio beep sequence. In this example, the fourth timing cue is a fourth audio beep sequence of only a single beep, representing both the start and the end of the fourth time period. AH of the beeps in the fourth audio beep sequence (even if there is only one) may be at the same frequency, volume, and duration, or those characteristics may vary. Each successive beep in the fourth audio beep sequence may be at a successively lower (or higher) frequency than the previous beep in the sequence. Also, the first beep may be at a different frequency than the last beep of the third beep sequence. These criteria help to further create a recognizable sound pattern for the actor. The actor knows to maintain the facial expression in the displayed image (in this example, a neutral expression) for the duration of this fourth time period. The actor knows the start and end of the fourth time period based on the timing cues.

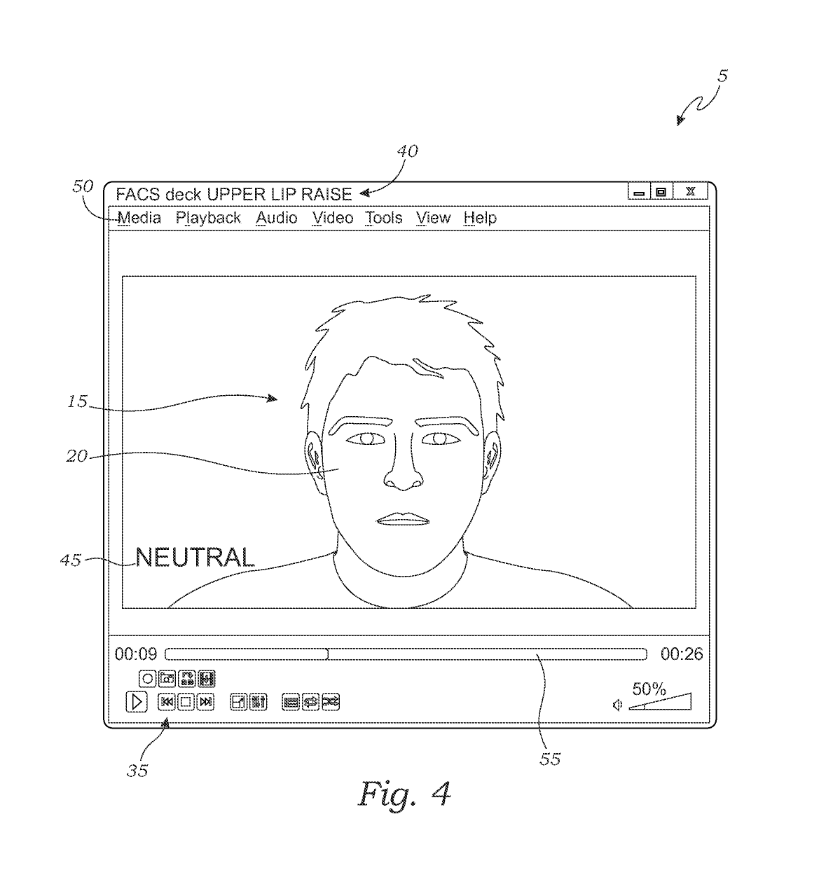

In the example described above, an actor thus has been shown a sequence of images with corresponding timing cues, directing the actor to mimic the images for the durations defined by the timing cues. The sequence of images has been described as: 1) a still shot of the desired facial pose (FIG. 1, first time period) to inform the actor of the pose; then 2) an image of a neutral expression (FIG. 2, second time period); then 3) an image of the facial pose (FIG. 3, third time period); and then 4) an image of the neutral expression again (FIG. 4, fourth time period). The actor thus transitions from the neutral expression to the posed expression to the neutral expression.

In one embodiment, the audio timing cues are: 1) beep-beep-beep (first time period) with all beeps at the same frequency; then 2) beep-beep (second time period) with the first beep starting at a higher frequency than the last beep of the first time period, and the second beep being at a higher frequency than the first beep; then 3) beep-beep (third time period) with the first beep starting at a higher frequency than the last beep of the second time period, and the second beep being at a lower frequency than the first beep; then 4) beep (fourth time period) at substantially the same frequency as the first beep of the second time period. In other words, if each beep frequency is represented by a number from 0 through 10, with 0 being the lowest frequency, and each successive number being a successively higher frequency, then the audio timing cues (beep sequences) for the first sequence of images in this embodiment could be represented by 0-0-0, 1-2, 3-2, 1.

As the actor performs a first set of facial expressions during one or more of the time periods as described above, the actor's facial expressions are captured as facial expression data as seen at Step 550, for later processing. At Step 555, the data is then associated with facial expression data corresponding to the facial expressions displayed on the images (Steps 510, 520, 530, 540), based at least in part on the timing cues. For example, software capturing and associating the facial expression data may be programmed to know the contents of the video deck, including: start and end times of each time period for a specific facial expression sequence; mode of expression during each time period; type/name of pose; number of captures of each sequence; and number of sequences. The software thus can determine what pose(s) is/are being captured, when the actor has a neutral expression or the posed expression(s), and when the actor is transitioning from one to the other, all based on the timing cues and video deck arrangement.

Step 550 is shown in the flowchart as occurring after Step 545 for simplicity, but the acquisition of facial expression data (Step 550) may occur at any time or multiple times during the process. Likewise, the data association (Step 555) is shown directly after Step 550, but may occur during or after the data acquisition, all at once or at different times for different poses.

In an embodiment where just a single facial expression type is being captured (e.g., “Upper Lip Raise”), the next step would be for the data file to be created as seen at Step 570. The data file should include the set of facial expression data just acquired, and associations of the data with facial expression data corresponding to the displayed facial expressions during the corresponding time periods. In other words, the actor's neutral expression may be tagged as NEUTRAL, the actor's posed expression may be tagged as “upper lip raise,” and transitions from one to the other may also be tagged as such. The process would then end as seen at Step 575, and the data file would then be ready for processing by a facial control system.

However, in some embodiments, the video deck will include repetitive sequences of the same facial expression, to allow for multiple captures of that expression data which can then be averaged or otherwise processed to allow for a more accurate rendering. This is reflected at Step 560. In other words, after the first data capture of a particular facial expression (e.g., “Upper Lip Raise”), if the video deck was programmed to repeat the sequence for a second capture, at Step 560 the question would be answered “NO,” and the process would then return to Step 510 for the second capture of “Upper Lip Raise” data.

Once the data capture sequence(s) for a particular pose is/are complete, the question at Step 560 is answered “YES,” and then if that was the only (or last) pose in the video deck, the question at Step 565 is answered “NO,” and the process proceeds to Step 570 to create the data file, then to Step 575 where it ends, as described herein. However, if the video deck includes additional facial expressions to be captured, the question at Step 565 is answered “YES,” and the process then returns to Step 505 to begin capture of the next set of facial expression data. Again, although Step 505 indicates a desired facial expression is selected, this may be automated based on the video deck arrangement.

A facial expression data capture session may proceed continuously by, e.g., playing the entire video deck with no interruptions. Or the video deck may be paused, replayed, forwarded, etc., as desired, using software control buttons 35 or otherwise. Once the complete video deck has “played,” and the actor's facial expressions and transitions have been captured, stored, and associated as described herein, the data file is ready for processing by a facial control system. For example, the data may be used to drive a character based on the actor's likeness, or can be retargeted onto another human or non-human character.

Although particular embodiments have been shown and described, the above description is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims. For example, although the invention has been described herein with use for capturing facial animation data, the invention can be used to capture other movements such as full body motion or movement of a specific body part or parts. As another example, although the audio timing cues have been described herein as beep sequences, they could also be voice commands, other sounds such as whoops, swishes, screeches, bells, horn music, drums, songs, or anything else. Accordingly, embodiments are intended to exemplify alternatives, modifications, and equivalents that may fall within the scope of the claims. The invention, therefore, should not be limited, except to the following claims, and their equivalents.

What is claimed is:

1. A method of acquiring facial motion data comprising:
a) displaying on an electronic display an image of a person with a first facial expression, for a first time period having a first start time and a first end time;
b) outputting a first timing cue during the first time period, the first timing cue including a timing cue representing the first start time and a timing cue representing the first end time;
c) displaying on the electronic display an image of the person with a second facial expression, for a second time period having a second start time and a second end time;
d) outputting a second timing cue during the second time period, the second timing cue including a timing cue representing the second start time and a timing cue representing the second end time;
e) displaying on the electronic display an image of the person with the first facial expression, for a third time period having a third start time and a third end time;
f) outputting a third timing cue during the third time period, the third timing cue including a timing cue representing the third start time and a timing cue representing the third end time;
g) displaying on the electronic display an image of the person with the second facial expression, for a fourth time period having a fourth start time and a fourth end time;
h) outputting a fourth timing cue during the fourth time period, the fourth timing cue including a timing cue representing the fourth start time and a timing cue representing the fourth end time;
i) acquiring a first set of facial expression data comprising facial expressions of an actor mimicking the facial expressions of the person on the display during the corresponding time periods;
j) associating the acquired facial expressions of the actor with facial expression data corresponding to facial expressions of the person on the display during the corresponding time periods, based at least in part on the timing cues; and
k) creating a data file comprising the first set of facial expression data, including associations of the acquired facial expressions of the actor with facial expression data corresponding to facial expressions of the person on the display during the corresponding time periods.

2. The method of claim 1, wherein the first facial expression is a posed facial expression and the second facial expression is a neutral facial expression.

3. The method of claim 2, further comprising displaying on the display during the first time period, a visual label identifying the posed facial expression.

4. The method of claim 1, wherein the first timing cue comprises a first audio cue, the second timing cue comprises a second audio cue, the third timing cue comprises a third audio cue, and the fourth timing cue comprises a fourth audio cue.

5. The method of claim 4, wherein the first audio cue comprises a first audio beep sequence, the second audio cue comprises a second audio beep sequence, the third audio cue comprises a third audio beep sequence, and the fourth audio cue comprises a fourth audio beep sequence.

6. The method of claim 5, wherein the first audio beep sequence begins with a first beep at a first frequency, the second audio beep sequence begins with a first beep at a second frequency different than the first frequency, and the third audio beep sequence begins with a first beep at a third frequency different than the first frequency and different than the second frequency.

7. The method of claim 6, wherein the fourth audio beep sequence begins with a first beep starting at a fourth frequency substantially the same as the second frequency.

8. The method of claim 6, wherein:
the first audio beep sequence comprises at least three beeps, and each of the beeps in the first audio beep sequence are at the first frequency;
the second audio beep sequence comprises at least two beeps, and each successive beep in the second audio beep sequence is at a successively higher frequency than the previous beep in the second audio beep sequence; and
the third audio beep sequence comprises at least two beeps, and each successive beep in the third audio beep sequence is at a successively lower frequency than the previous beep in the third audio beep sequence.

9. The method of claim 8, wherein the first beep in the third audio beep sequence is at a frequency higher than the last beep in the second audio beep sequence.

10. The method of claim 9, wherein the first audio beep sequence consists of three beeps, the second audio beep sequence consists of two beeps, the third audio beep sequence consists of two beeps, and the fourth audio beep sequence consists of one beep.

11. The method of claim 4, further comprising displaying on the display during the first time period, a visual label identifying the first facial expression.

12. The method of claim 4, further comprising displaying on the display during the first time period, a timing indicator corresponding to the first timing cue.

13. The method of claim 12, wherein the first timing cue comprises a first audio beep sequence, and further comprising displaying the timing indicator in synch with the first audio beep sequence.

14. The method of claim 4, further comprising displaying on the display during the second time period, a visual label identifying a facial mode associated with the second facial expression.

15. The method of claim 14, further comprising displaying on the display during the third time period, a visual label identifying a facial mode associated with the first facial expression.

16. The method of claim 15, further comprising displaying on the display during the fourth time period, a visual label identifying the facial mode associated with the second facial expression.

17. The method of claim 4, further comprising:
repeating steps a) through j) to acquire a second set of facial expression data representing the first and second facial expressions; and
outputting the second set of facial expression data to the data file, including associations of the acquired facial expressions of the actor from the second set of facial expression data with facial expression data corresponding to facial expressions of the person on the display during the corresponding time periods associated with the repeating of steps a) through j).

18. The method of claim 1, further comprising:
repeating steps a) through j) to acquire a second set of facial expression data representing the first and second facial expressions; and
outputting the second set of facial expression data to the data file, including associations of the acquired facial expressions of the actor from the second set of facial expression data with facial expression data corresponding to facial expressions of the person on the display during the corresponding periods associated with the repeating of steps a) through j).
